(19) United States
(12) Patent Application Publication
(10) Pub. No.: US 2025/0238059 A1
(43) Pub. Date: Jul. 24, 2025

(54) POWER SHARING OVER MULTIPLE POWER ADAPTORS

(71) Applicant: DELL PRODUCTS L.P., Round Rock, TX (US)

(72) Inventors: Wei-Cheng Yu, New Taipei City (TW); Merle Jackson Wood, III, Round Rock, TX (US); Chin Jui Liu, Taoyuan City (TW); Chi-Che Wu, Taipei (TW); Wen-Yung Chang, Jhong Li City (TW)

(21) Appl. No.: 18/418,543

(22) Filed: Jan. 22, 2024

(51) Int. Cl. G06F 1/26

(52) U.S. Cl. CPC G06F 1/266

(57) ABSTRACT

An information handling system includes first and second USB-C channels and a baseboard management controller (BMC). The first USB-C channel receives power from a first power adaptor, and the second USB-C channel receives power from a second power adaptor. The BMC determines an average current delivered to the information handling system from the first power adaptor and the second power adaptor, allocates a first portion of the average current to the first power adaptor and a second portion of the average current to the second power adaptor, and directs the first power adaptor to provide the first portion of the average current and the second power adaptor to provide the second portion of the average current.

### FIELD OF THE DISCLOSURE

This disclosure generally relates to information handling systems, and more particularly relates to enabling power sharing over multiple power adaptors in an in an information handling systems.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

### SUMMARY

An information handling system may include a first USB-C channel to receive power from a first power adaptor, and a second USB-C channel to receive power from a second power adaptor. A BMC may determine an average current delivered to the information handling system from the first power adaptor and the second power adaptor, allocate a first portion of the average current to the first power adaptor and a second portion of the average current to the second power adaptor, and direct the first power adaptor to provide the first portion of the average current and the second power adaptor to provide the second portion of the average current.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram of an information handling system according to an embodiment of the current disclosure;

FIG. 2 is a flowchart of a method for an information handling system to control the target current of a power adaptor according to an embodiment of the current disclosure;

FIG. 3 is a flowchart of a method to control the target current of a power adaptor according to another embodiment of the current disclosure; and

FIG. 4 is a block diagram illustrating a generalized information handling system according to another embodiment of the present disclosure.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

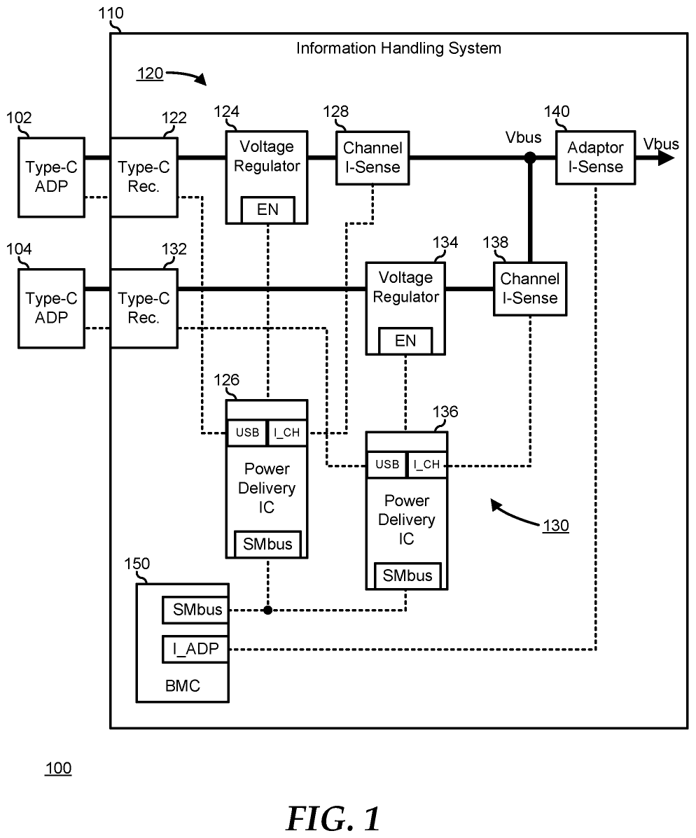

FIG. 1 illustrates a power system 100 for an information handling system 110. Power system 100 includes power adaptors 102 and 104, and information handling system 110. Power adaptors 102 and 104 provide power to charge and operate information handling system 110. For example, power adaptors 102 and 104 may represent AC power converters, DC power packs, or the like that provide DC power to information handling system 110. The DC power is provided to information handling system 110 via USB-C cables that are plugged into respective USB-C receptacles 122 and 132 of the information handling system. In this regard, power adaptors 102 and 104 may represent any type of device that is in conformance with one or more USB-C power delivery specification, and may include other types of information handling systems or devices that are configured to share power via USB-C power delivery mechanisms.

Power adaptors 102 and 104 may be similar to each other, in terms of power delivery ratings, voltage regulation ranges, current limits, or the like, or may represent differently specified power adaptors, as needed or desired. Moreover, it will be understood that one or more of power adaptors 102 and 104 may represent data or computing devices that are configured provide USB-based data transactions with information handling system 110, and also to provide power to charge the information handling system in conformance with one or more USB-C data transmission specifications. Such data transmission capabilities are beyond the scope of the current disclosure and will not be further described herein, except as may be needed to illustrate the current embodiments. The delivery of power by a power adaptor, and more particularly by a USB-C based power adaptor, are known in the art and will not be described further herein, except as may be needed to illustrate the current embodiments.

Information handling system 110 represents a computing device, such as a laptop computer, a tablet device, cell phone, or other mobile device, or any other type of device that is configured to be powered and charged by a USB-C adaptor such as adaptors 102 and 104. Information handling system 110 includes power converter channels 120 and 130, an adaptor current sensor 140, and a baseboard management controller (BMC) 150. Power converter channels 120 and 130 represent the power handling portions of the USB channels associated with USB-C receptacles 122 and 132. USB-C receptacles 122 and 132 also perform data transmission functions in accordance with one or more USB-C data transmission specification. Thus, as illustrated herein, connections between the elements of power system 100 that are illustrated as solid lines represent power connections, while connections that are illustrated as dashed lines represent data or other information connections (as described further below). A typical information handling system may include one or more additional USB-C interfaces as needed or desired.

Power converter channels 120 and 130 are configured to negotiate the power delivery parameters between respective power adaptors 102 and 104 and information handling system 110, and to provide the power received from the power adaptors to a particular voltage bus (Vbus) of the information handling system. The voltage bus (Vbus) is typically provided at a voltage level that is based on the configuration of a battery (not illustrated) of information handling system 110. Information handling system 110 may include additional power converter components (not illustrated) that are configured to convert the battery voltage (Vbus) to the various operating voltages needed by the information handling system (e.g., 5V, 3.3V, etc.). The conversion of a battery voltage bus to various other voltages needed by an information handling system is known in the art and will not be further described herein, except as may be needed to illustrate the current embodiments.

Power converter channel 120 includes USB-C receptacle 122, a voltage regulator 124, a power delivery integrated circuit (IC) 126, and a channel current sensor 128. USB-C receptacle 122 is connected to provide power from power adaptor 102 to an input of voltage regulator 124, and a power output of the voltage regulator provides the voltage bus (Vbus). Voltage regulator 124 operates to convert the voltage received from power adaptor 102 to the Vbus voltage. USB-C receptacle 122 is further connected to provide data (USB) to a data port (USB) of power delivery IC 126. The data connection (USB) enables power delivery IC 126 to negotiate the power delivery demands from adaptor 102 in accordance with one or more USB-C power delivery specifications, and as described further below. Power delivery IC 124 is connected to an enable (EN) input of voltage regulator 124 to provide an enable signal (EN) that directs the voltage regulator to turn on or to turn off, as needed or desired. The current provided by power adaptor 102 (I_CH) is measured by channel current sensor 128, and the current measured by the channel current sensor is provided to power delivery IC 126. Channel current sensor 128 may represent a small current sense resistor or another circuit to measure the current provided by power adaptor 102.

Power converter channel 130 is similar to power converter channel 120, and includes USB-C receptacle 132, a voltage regulator 134, and a power delivery integrated circuit (IC) 136. USB-C receptacle 132 is connected to provide power from power adaptor 104 to an input of voltage regulator 134, and a power output of the voltage regulator is connected to the voltage bus (Vbus). Voltage regulator 134 operates to convert the voltage received from power adaptor 104 to the Vbus voltage. USB-C receptacle 132 is further connected to provide data (USB) to a data port (USB) of power delivery IC 136. The data connection (USB) enables power delivery IC 136 to negotiate the power delivery demands from adaptor 104 in accordance with one or more USB-C power delivery specifications, and as described further below. Power delivery IC 134 is connected to an enable (EN) input of voltage regulator 134 to provide an enable signal (EN) that directs the voltage regulator to turn on or to turn off, as needed or desired. Note that power delivery ICs 126 and 136 are shown as separate components, but this is not necessarily so, and the power delivery ICs may be integrated into a single component, as needed or desired. Further, one or more additional power delivery IC may be integrated into the single component, as needed or desired. The current provided by power adaptor 104 (I_CH) is measured by channel current sensor 138, and the current measured by the channel current sensor is provided to power delivery IC 136. Channel current sensor 138 may represent a small current sense resistor or another circuit to measure the current provided by power adaptor 104.

In a particular embodiment, information handling system 110 operates to select one of power adaptors 102 and 104 to provide power to charge and operate the information handling system, while the other power adaptor remains idle. In particular, in furtherance of the negotiations for power delivery between power adaptor 102 and power delivery IC 126, and between power adaptor 104 and power delivery IC 136, the power delivery ICs operate select one of the power adaptors to provide power and to select the other power adaptor to remain idle. The power delivery IC 126 or 136 associated with the power adaptor 102 or 104 selected to provide power operates to enable the associated voltage regulator 124 or 134, and the other power delivery IC operates to disable the other voltage regulator. In a particular case, power delivery ICs 126 and 136 operate to select the particular one of power adaptors 102 and 104 that is rated to provide the highest power charging for information handling system 110. Power delivery ICs 126 and 136 may operate to communicate with each other to make the determination, for example via a System Management Bus (SMbus) connection between the power delivery ICs. As used herein, when power adaptors 102 and 104 are referred to as remaining idle, such attribution relates to the provision of power to information handling system 110, and may not necessarily relate to data transactions between the power adaptors and the information handling system, except as may be needed in the furtherance of the current embodiments, as described below.

Information handling system 110 will be understood to draw a current from power adaptors 102 and 104 to charge the battery and to operate the information handling system. The current provided by power adaptors 102 and 104 (I_ADP) is measured by adaptor current sensor 140. The current measured by current sensor 140 (I_ADP) may differ from a system current needed just to operate the components of information handling system 110, some or all of which may be provided by the battery. In contrast, the current detected by current sensor 140 (I_ADP) may represent an amount of current needed to charge the battery, all or a portion of the amount of current needed to operate information handling system 110, or both amounts of current. Thus, in a first case, when the battery is in need of charging, the current measured by current sensor 140 (I_ADP) may be include all of the system current plus a battery charging current.

In a second case, when the system current is closely matched to the current capacity of power adaptors 102 and 104, and the battery is fully charged, the current measured by current sensor 140 (I_ADP) may be substantially equal to the system current. In a third case, when the system current is greater than the current capacity of power adaptors 102 and 104, then the current measured by current sensor 140 (I_ADP) may be less than the system current, the balance of the system current being provided by the battery. This case may be particularly relevant when only one of power adaptors 102 and 104 are providing power to information handling system 110, as described above. Current sensor 140 may represent a small current sense resistor or another circuit to measure the current provided by adaptors 102 and 104 (I_ADP).

In a particular embodiment, information handling system 110 operates to draw power from both power adaptors 102 and 104 simultaneously. In particular, BMC 150 receives the current measured by current sensor 140 and determines an average current (I_ADP_AVG) over a duration of time in order to filter out instantaneous peak current demand. BMC 150 then directs power delivery ICs 126 and 136 to retrieve Power Data Objects (PDOs) from power adaptors 102 and 104. The PDOs describe the power delivery capabilities of power adaptors 102 and 104, and respective power delivery ICs 126 and 136 typically respond to the receipt of the PDOs with Request Data Objects (RDOs) that specify PDO indexes to select the power profile to be provided by the power adaptors. BMC 150 then operates to allocate portions of the average current (I_ADP_AVG) between power adaptors 102 and 104 based upon the received PDOs.

In a particular case, BMC 150 operates to allocate the portion of the average current (I_ADP_AVG) in proportion to the rated power of power adaptor 102 (P_ADP_1) and of power adaptor 104 (P_ADP_2). Thus, the current from power adaptor 102 may be provided as:

I_ADP_1=(P_ADP_1/(P_ADP_1+P_ADP_2))*I_ADP_AVG Equation 1,

and the current from power adaptor 104 may be provided as:

I_ADP_2=(P_ADP_2/(P_ADP_1+P_ADP_2))*I_ADP_AVG Equation 2,

where I_ADP_1 is the current allocation for power adaptor 102, and I_ADP_2 is the current allocation for power adaptor 104. For example, assume that power adaptor 102 is a 60 W power adaptor (P_ADP_1), that power adaptor 104 is a 90 W power adaptor (P_ADP_2), and that the average current (I_ADP_AVG) is 3 A. Then, from Equation 1, the current allocation for adaptor 102 (I_ADP_1) is (60/(60+90))*3 A=1.2 A, and, from Equation 2, the current allocation for adaptor 104 (I_ADP_2) is (90/(60+90))*3 A=1.8 A.

In another case, BMC 150 operates to allocate a portion of the average current (I_ADP_AVG) to maximize an output current from one of power adaptors 102 and 104, and to allocate any remaining current from the other power adaptor. For example, assume that power adaptor 102 has a maximum continuous current rating of 4 A, that power adaptor 104 has a maximum continuous current rating of 2 A, and that the average current (I_ADP_AVG) is 5 A. In a first instance, BMC 150 may provide a current allocation of 4 A from power adaptor 102 (that is, the maximum current for power adaptor 102) and a current allocation of 1 A from power adaptor 104 (that is, the remaining current from power adaptor 104). In another instance, BMC 150 may provide a current allocation of 2 A from power adaptor 104 (that is, the maximum current for power adaptor 104) and a current allocation of 3 A from power adaptor 102 (that is, the remaining current from power adaptor 102).

In another case, BMC 150 operates to allocate the average current (I_ADP_AVG) equally between power adaptors 102 and 104 until the maximum current output of one of the power adaptors is reached, and then allocating any additional current demand to the other power adaptor. For example, using the above assumption where power adaptor 102 has a maximum continuous current rating of 4 A, that power adaptor 104 has a maximum continuous current rating of 2 A, then, for any average current (I_ADP_AVG) less than or equal to 4 A, BMC 150 operates to provide equal current allocations to both power adaptors 102 and 104. Then, when the average current (I_ADP_AVG) exceeds 4 A, the BMC operates to provide the excess current allocation to power adaptor 102.

In any of the above described cases, a transition from a single power adaptor to multiple power adaptors may necessitate the determination of a battery current in addition to an adaptor current, because, where one power adaptor is supplying current, the determination of the adaptor current may provide an insufficient basis to spin up additional power adaptors. For example, consider a case where a power adaptor is providing its maximum current, but that the supplied current is insufficient to power the information handling system. The information handling system may draw additional current from the battery. However in this case, the determination of the average adaptor current would be insufficient to utilize any additional current capacity provided by the additional power adaptors. Thus, the cases for determining the average current may be suitably modified to account for transitions from single a single power adaptor to multiple power adaptors, as needed or desired.

After the current allocations for power adaptors 102 and 104 are determined, BMC 150 operates to direct power delivery ICs 126 and 136 to communicate with their respective power adaptors to achieve the determined current allocations. In a particular embodiment, power delivery ICs 126 and 136 operate to direct respective power adaptors 102 and 104 to adjust the output voltages of the power adaptors to achieve the desired currents from the power adaptors. In particular, power delivery IC 126 directs power adaptor 102 to adjust the output voltage of the power adaptor to achieve the determined current allocation. Likewise, power delivery IC 136 directs power adaptor 104 to adjust the output voltage of the power adaptor to achieve the determined current allocation. In this embodiment, power delivery ICs 126 and 136 operate to ensure the delivery of their respective allocated currents based on the individual power adaptor currents (I_CH_1 and I_CH_2) as measured by respective channel current sensors 128 and 138. Then, if one or the other of the currents measured by channel current sensors 128 or 138 deviates from their respective allocated current, the associated one of power delivery ICs 126 or 136 operates to direct the associated one of power adaptors 102 or 104 to adjust their output voltage upwards or downwards to adjust the measured currents.

Power adaptors 102 and 104 operate to determine their respective average currents to respective power delivery ICs 126 and 136. In particular, power delivery ICs 126 and 136 are configured to provide time mapping commands to respective power adaptors 102 and 104. In response to receiving the time mapping commands, power adaptors 102 and 104 operate to provide a time mapped sampling of analog-to-digital converters (ADCs) that measure the respective currents at the sampling times, and to average the current measurements across the sampling times. Power delivery ICs 126 and 136 can then provide “GET_V/I” command to request respective power adaptors 102 and 104 to provide the average current provided by the power adaptors in a “ADP_V/I” response.

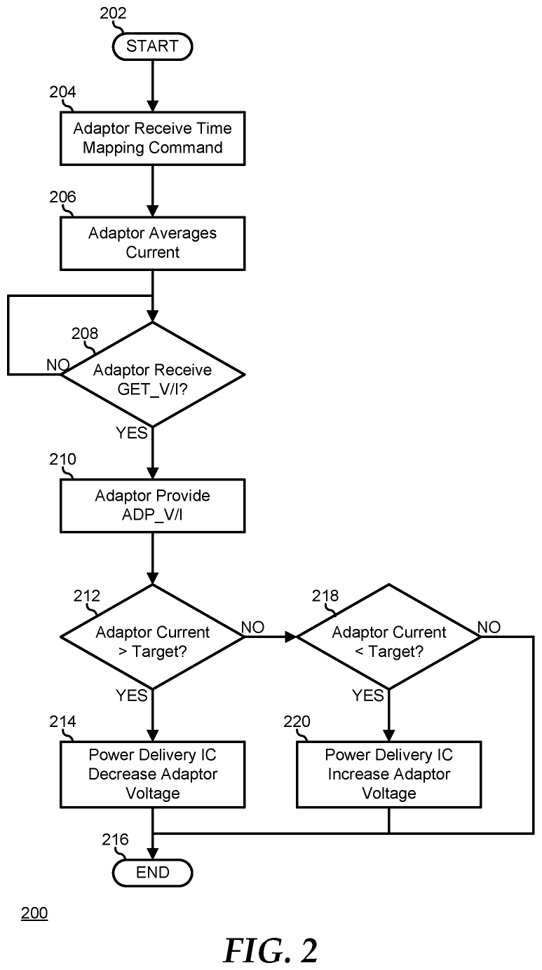

FIG. 2 illustrates a method 200 for an information handling system to control the target current of a power adaptor, starting at block 202. A power adaptor receives a time mapping command in block 204, and the power adaptor determines the average current in block 206. A decision is made as to whether or not the power adaptor has received a GET_V/I command from a power delivery IC in decision block 208. If not, the “NO” branch of decision block 208 is taken and the method returns to decision block 208 until the GET_V/I command is received. When the GET_V/I command is received, the “YES” branch of decision block 208 is taken and the power adaptor provides the ADP_V/I response to the power delivery IC in block 210.

A decision is made as to whether or not the adaptor current is greater than the target current for the power adaptor in decision block 212. For example, a BMC can compare the average current received from the power adaptor in the SDP_V/I response with the target current. If the adaptor current is greater than the target current, the “YES” branch of decision block 212 is taken, the power delivery IC directs the power adaptor to decrease the output voltage in block 214, and the method ends in block 216. If the adaptor current is not greater than the target current, the “NO” branch of decision block 212 is taken, and a decision is made as to whether or not the adaptor current is less than the target current for the power adaptor in decision block 218. If so, the “YES” branch of decision block 218 is taken, the power delivery IC directs the power adaptor to increase the output voltage in block 220, and the method ends in block 216. If the adaptor current is not less than the target current, then the adaptor current is equal to the target current, the “NO” branch of decision block 218 is taken and the method ends in block 216.

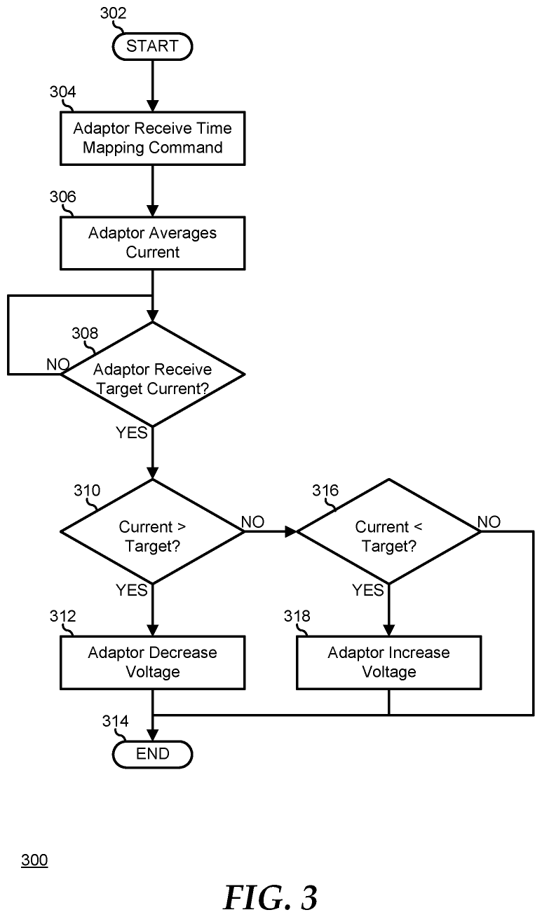

In another embodiment, power delivery ICs 126 and 136 operate to direct respective power adaptors 102 and 104 to provide the respective current allocations, and the power adaptors operate to maintain their output voltage levels to achieve the desired currents. FIG. 3 illustrates a method 300 for an information handling system to control the target current of a power adaptor, starting at block 302. A power adaptor receives a time mapping command in block 304, and the power adaptor determines the average current in block 306. A decision is made as to whether or not the power adaptor has received a target current from a power delivery IC in decision block 308. If not, the “NO” branch of decision block 308 is taken and the method returns to decision block 308 until the target current is received. When the target current is received, the “YES” branch of decision block 308 is taken and a decision is made as to whether or not the adaptor current is greater than the target current for the power adaptor in decision block 310.

If so, the “YES” branch of decision block 310 is taken, the power adaptor decreases the output voltage in block 312, and the method ends in block 314. If the adaptor current is not greater than the target current, the “NO” branch of decision block 310 is taken, and a decision is made as to whether or not the adaptor current is less than the target current for the power adaptor in decision block 316. If so, the “YES” branch of decision block 316 is taken, the power adaptor increases the output voltage in block 318, and the method ends in block 314. If the adaptor current is not less than the target current, then the adaptor current is equal to the target current, the “NO” branch of decision block 316 is taken and the method ends in block 314.

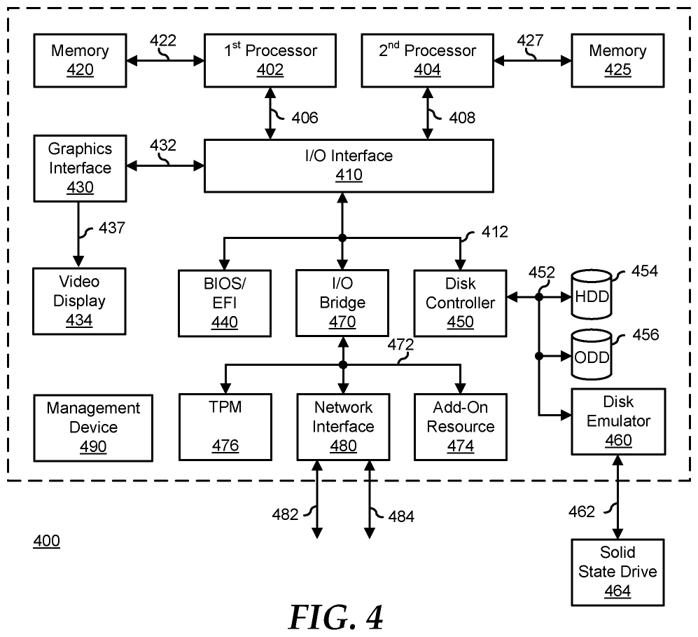

FIG. 4 illustrates a generalized embodiment of an information handling system 400. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 400 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 400 can include processing resources for executing machine-executable code, such as a central processing unit (CPU), a programmable logic array (PLA), an embedded device such as a System-on-a-Chip (SoC), or other control logic hardware. Information handling system 400 can also include one or more computer-readable medium for storing machine-executable code, such as software or data. Additional components of information handling system 400 can include one or more storage devices that can store machine-executable code, one or more communications ports for communicating with external devices, and various input and output (I/O) devices, such as a keyboard, a mouse, and a video display. Information handling system 400 can also include one or more buses operable to transmit information between the various hardware components.

Information handling system 400 can include devices or modules that embody one or more of the devices or modules described below, and operates to perform one or more of the methods described below. Information handling system 400 includes a processors 402 and 404, an input/output (I/O) interface 410, memories 420 and 425, a graphics interface 430, a basic input and output system/universal extensible firmware interface (BIOS/UEFI) module 440, a disk controller 450, a hard disk drive (HDD) 454, an optical disk drive (ODD) 456, a disk emulator 460 connected to an external solid state drive (SSD) 464, an I/O bridge 470, one or more add-on resources 474, a trusted platform module (TPM) 476, a network interface 480, a management device 490, and a power supply 495. Processors 402 and 404, I/O interface 410, memory 420, graphics interface 430, BIOS/UEFI module 440, disk controller 450, HDD 454, ODD 456, disk emulator 460, SSD 464, I/O bridge 470, add-on resources 474, TPM 476, and network interface 480 operate together to provide a host environment of information handling system 400 that operates to provide the data processing functionality of the information handling system. The host environment operates to execute machine-executable code, including platform BIOS/UEFI code, device firmware, operating system code, applications, programs, and the like, to perform the data processing tasks associated with information handling system 400.

In the host environment, processor 402 is connected to I/O interface 410 via processor interface 406, and processor 404 is connected to the I/O interface via processor interface 408. Memory 420 is connected to processor 402 via a memory interface 422. Memory 425 is connected to processor 404 via a memory interface 427. Graphics interface 430 is connected to I/O interface 410 via a graphics interface 432, and provides a video display output 436 to a video display 434. In a particular embodiment, information handling system 400 includes separate memories that are dedicated to each of processors 402 and 404 via separate memory interfaces. An example of memories 420 and 425 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 440, disk controller 450, and I/O bridge 470 are connected to I/O interface 410 via an I/O channel 412. An example of I/O channel 412 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 410 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 440 includes BIOS/UEFI code operable to detect resources within information handling system 400, to provide drivers for the resources, initialize the resources, and access the resources. BIOS/UEFI module 440 includes code that operates to detect resources within information handling system 400, to provide drivers for the resources, to initialize the resources, and to access the resources.

Disk controller 450 includes a disk interface 452 that connects the disk controller to HDD 454, to ODD 456, and to disk emulator 460. An example of disk interface 452 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 460 permits SSD 464 to be connected to information handling system 400 via an external interface 462. An example of external interface 462 includes a USB interface, an IEEE 2394 (Firewire) interface, a proprietary interface, or a combination thereof. Alternatively, solid-state drive 464 can be disposed within information handling system 400.

I/O bridge 470 includes a peripheral interface 472 that connects the I/O bridge to add-on resource 474, to TPM 476, and to network interface 480. Peripheral interface 472 can be the same type of interface as I/O channel 412, or can be a different type of interface. As such, I/O bridge 470 extends the capacity of I/O channel 412 when peripheral interface 472 and the I/O channel are of the same type, and the I/O bridge translates information from a format suitable to the I/O channel to a format suitable to the peripheral channel 472 when they are of a different type. Add-on resource 474 can include a data storage system, an additional graphics interface, a network interface card (NIC), a sound/video processing card, another add-on resource, or a combination thereof. Add-on resource 474 can be on a main circuit board, on separate circuit board or add-in card disposed within information handling system 400, a device that is external to the information handling system, or a combination thereof.

Network interface 480 represents a NIC disposed within information handling system 400, on a main circuit board of the information handling system, integrated onto another component such as I/O interface 410, in another suitable location, or a combination thereof. Network interface device 480 includes network channels 482 and 484 that provide interfaces to devices that are external to information handling system 400. In a particular embodiment, network channels 482 and 484 are of a different type than peripheral channel 472 and network interface 480 translates information from a format suitable to the peripheral channel to a format suitable to external devices. An example of network channels 482 and 484 includes InfiniBand channels, Fibre Channel channels, Gigabit Ethernet channels, proprietary channel architectures, or a combination thereof. Network channels 482 and 484 can be connected to external network resources (not illustrated). The network resource can include another information handling system, a data storage system, another network, a grid management system, another suitable resource, or a combination thereof.

Management device 490 represents one or more processing devices, such as a dedicated baseboard management controller (BMC) System-on-a-Chip (SoC) device, one or more associated memory devices, one or more network interface devices, a complex programmable logic device (CPLD), and the like, that operate together to provide the management environment for information handling system 400. In particular, management device 490 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 400, such as system cooling fans and power supplies. Management device 490 can include a network connection to an external management system, and the management device can communicate with the management system to report status information for information handling system 400, to receive BIOS/UEFI or system firmware updates, or to perform other task for managing and controlling the operation of information handling system 400. Management device 490 can operate off of a separate power plane from the components of the host environment so that the management device receives power to manage information handling system 400 when the information handling system is otherwise shut down. An example of management device 490 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like.

Management device 490 may further include associated memory devices, logic devices, security devices, or the like, as needed or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An information handling system, comprising:
a first USB-C channel configured to receive power from a first power adaptor;
a second USB-C channel configured to receive power from a second power adaptor; and
a baseboard management controller (BMC) configured to determine an average current delivered to the information handling system from the first power adaptor and the second power adaptor, to allocate a first portion of the average current to the first power adaptor and a second portion of the average current to the second power adaptor, and to direct the first power adaptor to provide the first portion of the average current and the second power adaptor to provide the second portion of the average current.

2. The information handling system of claim 1, wherein, in allocating the first portion of the average current to the first power adaptor and the second portion of the average current to the second power adaptor, the BMC is further configured to set a voltage level of the first power adaptor.

3. The information handling system of claim 2, wherein, after setting the voltage level of the first power adaptor, the BMC is further configured to determine an adaptor current provided by the first power adaptor, to compare the adaptor current to the first portion of the average current, and to determine whether the adaptor current is greater than or less than the first portion of the average current.

4. The information handling system of claim 3, wherein:
when the first current is greater than the first portion of the average current, the BMC is further configured to decrease the voltage level of the first power adaptor; and
when the first current is less than the first portion of the average current, the BMC is further configured to increase the voltage level of the first power adaptor.

5. The information handling system of claim 1, wherein, in allocating the first portion of the average current to the first power adaptor and the second portion of the average current to the second power adaptor, the BMC is further configured to set a first current output from the first power adaptor to the first portion of the average current, and to set a second current output from the second power adaptor to the second portion of the average current.

6. The information handling system of claim 1, wherein, in allocating the first portion of the average current to the first power adaptor and the second portion of the average current to the second power adaptor, the BMC is further configured to determine a first current capacity of the first power adaptor and a second current capacity of the second power adaptor.

7. The information handling system of claim 6, wherein, in allocating the first portion of the average current to the first power adaptor and the second portion of the average current to the second power adaptor, the BMC is further configured to set the first current in proportion to the average current as the first current capacity is to a sum of the first current capacity and the second current capacity.

8. The information handling system of claim 7, wherein, in allocating the first portion of the average current to the first power adaptor and the second portion of the average current to the second power adaptor, the BMC is further configured to set the second current in proportion to the average current as the second current capacity is to the sum.

9. The information handling system of claim 6, wherein, in allocating the first portion of the average current to the first power adaptor and the second portion of the average current to the second power adaptor, the BMC is further configured to set the first portion of the average current equal to the first current capacity, and to set the second portion of the average current equal to a remainder of the average current.

10. The information handling system of claim 1, wherein, in allocating the first portion of the average current to the first power adaptor and the second portion of the average current to the second power adaptor, the BMC is further configured to allocate the average current equally between the first power adaptor and the second power adaptor.

11. A method, comprising:
providing, in an information handling system, a first USB-C channel configured to receive power from a first power adaptor;
providing, in the information handling system, a second USB-C channel configured to receive power from a second power adaptor;
determining, by a baseboard management controller (BMC), an average current delivered to the information handling system from the first power adaptor and the second power adaptor;
allocating a first portion of the average current to the first power adaptor and a second portion of the average current to the second power adaptor; and
directing the first power adaptor to provide the first portion of the average current and the second power adaptor to provide the second portion of the average current.

12. The method of claim 11 wherein, in allocating the first portion of the average current to the first power adaptor and the second portion of the average current to the second power adaptor, the method further comprises setting, by the BMC, a voltage level of the first power adaptor.

13. The method of claim 12 wherein, after setting the voltage level of the first power adaptor, the method further comprises:
determining, by the BMC, an adaptor current provided by the first power adaptor;
comparing the adaptor current to the first portion of the average current; and
determining whether the adaptor current is greater than or less than the first portion of the average current.

14. The method of claim 13, wherein:
when the first current is greater than the first portion of the average current, method further comprises decreasing, by the BMC, the voltage level of the first power adaptor; and
when the first current is less than the first portion of the average current, the method further comprises increasing, by the BMC, the voltage level of the first power adaptor.

15. The method of claim 11, wherein, in allocating the first portion of the average current to the first power adaptor and the second portion of the average current to the second power adaptor, the method further comprises:
setting, by the BMC, a first current output from the first power adaptor to the first portion of the average current; and
setting, by the BMC, a second current output from the second power adaptor to the second portion of the average current.

16. The method of claim 11 wherein, in allocating the first portion of the average current to the first power adaptor and the second portion of the average current to the second power adaptor, the method further comprises determining a first current capacity of the first power adaptor and a second current capacity of the second power adaptor.

17. The method of claim 16 wherein, in allocating the first portion of the average current to the first power adaptor and the second portion of the average current to the second power adaptor, the method further comprises setting the first current in proportion to the average current as the first current capacity is to a sum of the first current capacity and the second current capacity.

18. The method of claim 17 wherein, in allocating the first portion of the average current to the first power adaptor and the second portion of the average current to the second power adaptor, the method further comprises setting the second current in proportion to the average current as the second current capacity is to the sum.

19. The method of claim 16, wherein, in allocating the first portion of the average current to the first power adaptor and the second portion of the average current to the second power adaptor, the method further comprises:
setting the first portion of the average current equal to the first current capacity; and
setting the second portion of the average current equal to a remainder of the average current.

20. An information handling system, comprising:
a first USB-C channel having a first USB-C receptacle configured to receive power from a first power adaptor, and a first power delivery integrated circuit;
a second USB-C channel having a second USB-C receptacle configured to receive power from a second power adaptor, and a second power delivery integrated circuit; and
a baseboard management controller (BMC) coupled to the first power delivery integrated circuit and to the second power delivery integrated circuit, the BMC being configured to determine an average current delivered to the information handling system from the first power adaptor and the second power adaptor, to allocate a first portion of the average current to the first power adaptor and a second portion of the average current to the second power adaptor, to direct the first power delivery integrated circuit to communicate the first portion to the first power adaptor, and to direct the second power delivery integrated circuit to communicate the second portion of the average current to the second power adaptor.
